(19) United States
(12) Patent Application Publication
(10) Pub. No.: US 2010/0064539 A1
(43) Pub. Date: Mar. 18, 2010

(54) Keeper tape

(76) Inventor: Willam M. Jacobs, Bozeman, MT (US)

Correspondence Address: WILLIAM JACOBS, 36 Summer Cutoff, BOZEMAN, MT, 59715, US

(21) Appl. No.: 12/386,171

(22) Filed: Apr. 15, 2009

Related U.S. Application Data
(60) Provisional application No. 61/045,820, filed on Apr. 17, 2008.

(51) Int. Cl. A45B 3/08; A01M 99/00

(52) U.S. Cl. 33/700; 43/1

(57) ABSTRACT

The invention makes any fishing rod an accurate measuring device. An angler may immediately determine the length of a fish for determining legal catch size or record data.

### BACKGROUND OF INVENTION

Prior to this application, devises for measuring fish with a fishing rod required purchase of a new rod or professional modification. All previous inventions investigated affected rod performance thru flex restriction or excessive weight. The tape in this application has no moving parts, therefore, not subject to mechanical breakdown.

### SUMMARY OF THE INVENTION

This invention eliminates the need for mechanical devises previously designed for the purpose of measuring fish. The tape is removable and requires no modification be done to the fishing rod. The plastic tape flexes with the rod and will not affect performance. The numbers are easily read and are U.V. resistant. The tape is produced with a removable paper backing which allows for easy, one piece installation without the need of special tools.

### SUMMARY OF DRAWINGS

FIG. 1 shows an exploded sectional view of the tape and how it would be positioned on a fishing rod.

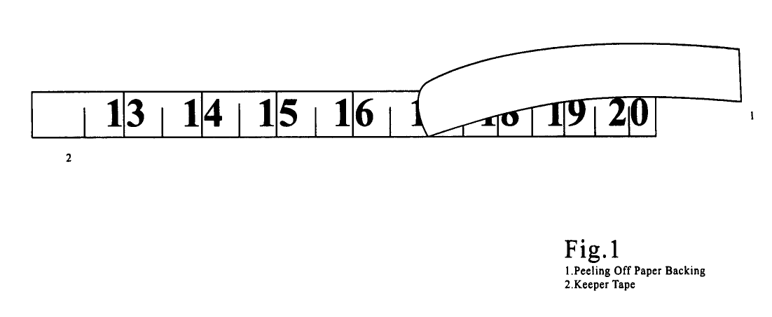

FIG. 2 shows a sectional view of the tape removed from the paper backing.

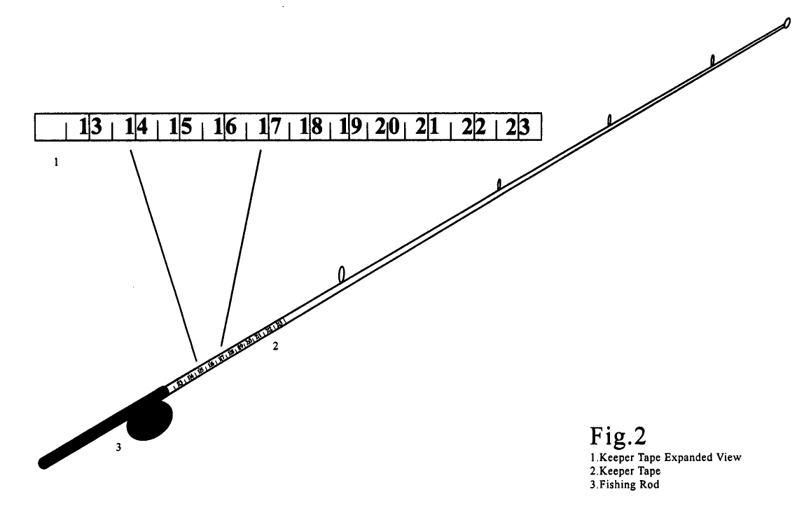

FIG. 3 shows the paper backing being removed from the tape.

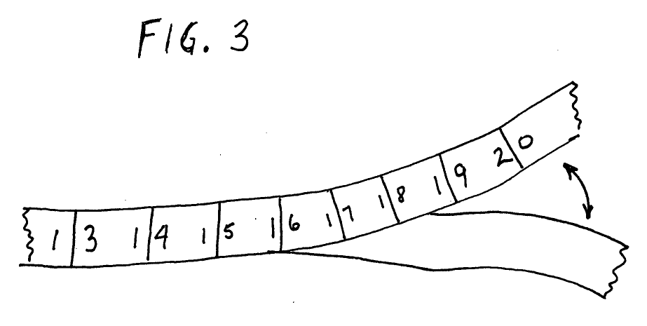

### DESCRIPTION

The present invention relates to a clear measuring tape affixed to a removable paper backing that self adheres to a fishing rod. The tape measures approximately ⅝×24 inches and is marked in inches and half inches, with a water resistant adhesive and U.V. resistant numbers.

1. The tape accurately measures fish up to thirty-six inches in length without the need to carry a separate device.
